(19) United States
(12) Patent Application Publication
(10) Pub. No.: US 2017/0014788 A1
(43) Pub. Date: Jan. 19, 2017

(54) APPARATUS AND METHOD FOR DISPERSING AND MIXING FLUIDS BY FOCUSED ULTRASOUND AND FLUID FEEDER FOR DISPERSING AND MIXING FLUIDS BY FOCUSED ULTRASOUND

(71) Applicant: KOREA RESEARCH INSTITUTE OF STANDARD AND SCIENCE, Daejeon (KR)

(72) Inventors: Min Cheol CHU, Daejeon (KR); Seon Ae HWANGBO, Busan (KR); Sae Won YOON, Daejeon (KR)

(73) Assignee: KOREA RESEARCH INSTITUTE OF STANDARDS AND SCIENCE, Daejeon (KR)

(21) Appl. No.: 14/436,899

(22) PCT Filed: Aug. 29, 2014
(86) PCT No.: PCT/KR2014/007970

§ 371 Date: Apr. 20, 2015

(30) Foreign Application Priority Data
Apr. 11, 2014 (KR) 10-2014-0043398
Jul. 22, 2014 (KR) 10-2014-0092302

(51) Int. Cl. B01F 11/02; B01F 15/00; B01F 3/08

(52) U.S. Cl. CPC B01F 11/0266; B01F 3/0819; B01F 11/0291; B01F 15/00207; B01F 15/0022; B01F 15/00214; B01F 3/0803; B01F 15/00233; B01F 15/00324; B01F 2215/0031; B01F 2215/0014; B01F 2215/0032

(57) ABSTRACT

Disclosed is a method for preparing a stable fluid mixture by mixing hydrophilic and hydrophobic substances using ultrasound wherein homogeneous dispersion and mixing are possible so that dispersibility is greatly improved and separation between the hydrophilic and hydrophobic substances is minimized even after a long time.

The apparatus for dispersing and mixing fluids by focused ultrasound includes a fluid storage unit for storing a fluid mixture of at least two fluids comprising a hydrophilic substance and a hydrophobic substance, the fluid storage unit comprising a first connector and a second connector connected to a fluid flow path such that the fluid mixture moves through a fluid flow path providing a portion through which the fluid mixture moves, a fluid dispersion unit for focusing ultrasound to a portion of the fluid flow path to disperse fluids contained in the fluid mixture by ultrasound when the fluid mixture moves the portion, and a fluid circulation unit for circulating the fluid mixture such that a portion of the fluid mixture relatively insufficiently dispersed is moved through the first connector from the fluid storage unit to the fluid dispersion unit and the fluid mixture dispersed by the fluid dispersion unit is moved through the second connector to the fluid storage unit.

### TECHNICAL FIELD

The present invention relates to a method for dispersing and mixing a fluid mixture comprising hydrophilic and hydrophobic fluids. More specifically, the present invention relates to a method for homogeneously and stably dispersing fluids by ultrasound without adding mixtures, such as surfactants, for mixing hydrophilic and hydrophobic fluids.

### BACKGROUND ART

In recent years, a variety of substances are used to improve qualities of cosmetics, seasonings, medicines and the like. These substances are mixed with one another and are thus processed into products, and are commercially available as mixtures with a liquid such as water for edible, cosmetic or medical applications.

Substances used for the products are divided into hydrophilic and hydrophobic substances. Hydrophilic substances are well miscible with water and have a chemical structure containing a hydrophilic group, while hydrophobic substances are well immiscible with water and oil, which is a representative example of the hydrophobic substances, has a chemical structure containing a hydrophobic group.

Accordingly, products obtained from a mixture of hydrophilic and hydrophobic substances are inevitably sold as fluids which are immiscible with each other. In this case, a great deal of research for developing fluids in which hydrophilic and hydrophobic substances are homogeneously mixed has been continued to solve quality deterioration and unsuitable appearance of products.

A mixture of surfactants (emulsifiers) or the like contains both hydrophilic and lipophilic groups and is used to homogeneously mix hydrophilic and hydrophobic substances such as water and oils. However, regarding such a mixture, another mixture according to type of oil may be required and addition of the other mixture may have negative effects on the human body. Thus, there is an urgent need for methods for mixing hydrophilic and hydrophobic substances without using such a mixture.

Techniques for dispersing and mixing substances and the like by ultrasound have been suggested to solve these problems. Representative techniques that have been used for ultrasound dispersion include bath, cup and horn type techniques. However, with such ultrasound dispersion and mixing technique, it is disadvantageously difficult to disperse and mix large amounts of fluids. A phenomenon, so-called cavitation in which static pressure in flowing water is not higher than a vapor pressure, water evaporates and bubbles are thus created in air penetrated in flowing water due to low pressure, thus resulting in noise, vibration and precipitation. It has been pointed out that it is a limitation in dispersibility because particles are dispersed and mixed at a micrometer-scale and that there is instability in which hydrophilic and hydrophobic substances are separated with time due to micrometer-scale large dispersed particles as described above.

### DISCLOSURE OF INVENTION

### Technical Problem

Therefore, the present invention has been made in view of the above problems, and it is one object of the present invention to provide a method for preparing a stable fluid mixture by mixing hydrophilic and hydrophobic substances into nano emulsion, using ultrasound and without using emulsifier wherein the dispersion and mixing are homogeneous by dispersing the substances in nano meter size, dispersion capacity is greatly improved, and separation between the hydrophilic and hydrophobic substances is minimized even after a long time.

It is another object of the present invention to provide a fluid feeder for homogeneously dispersing and mixing fluids to improve dispersion efficiency.

### Solution to Problem

In accordance with an aspect of the present invention, the above and other objects can be accomplished by the provision of an apparatus for dispersing and mixing fluids by focused ultrasound including a fluid storage unit for storing a fluid mixture of at least two fluids comprising a hydrophilic substance and a hydrophobic substance, the fluid storage unit comprising a first connector and a second connector connected to a fluid flow path providing a path through which the fluid mixture flows to allow the fluid mixture to flow through the fluid flow path, a fluid dispersion unit for focusing ultrasound to a portion of the fluid flow path to disperse the fluids contained in the fluid mixture by ultrasound when the fluid mixture reaches the portion of the fluid flow path, and a fluid circulation unit for circulating the fluid mixture such that a portion of the fluid mixture relatively insufficiently dispersed flows through the first connector from the fluid storage unit to the fluid dispersion unit and the fluid mixture dispersed by the fluid dispersion unit flows through the second connector to the fluid storage unit.

In accordance with another aspect of the present invention, there is provided a fluid feeder including a fluid storage unit for providing a fluid flow path through which a fluid mixture of a hydrophilic fluid and a hydrophobic fluid flows, the fluid storage unit being connected through a plurality of connectors to the fluid flow path having a portion, in which an ultrasound focusing unit for focusing ultrasound to disperse and mix the fluids contained in the fluid mixture by focused ultrasound is mounted, to flow the fluid mixture in the fluid flow path and to flow the fluid mixture dispersed by the ultrasound focusing unit through the fluid flow path, and a pre-treatment unit for dispersing the fluid mixture at micrometer scale and supplying the same to the fluid storage unit before the fluid mixture is stored in the fluid storage unit.

### Advantageous Effects of Invention

According to the present invention, hydrophilic and hydrophobic substances are dispersed in nano meter size and, at the same time, are mixed by focusing ultrasound whose frequency is more higher than the previous techniques for dispersing and mixing substances by ultrasound, upon a fluid flow path, thus advantageously providing a fluid mixture in which the hydrophilic substance and the hydrophobic substances are homogeneously dispersed and mixed into nano emulsion without using emulsifier.

In addition, according to the configuration described above, separation of hydrophilic and hydrophobic substances from the fluid mixture is minimized even after a predetermined time, thus advantageously providing a stable fluid mixture.

Meanwhile, according to the configuration described above, a structure for dispersing and mixing a great amount of fluids can be formed and homogeneous and stable fluid mixture can thus be mass-produced.

### BRIEF DESCRIPTION OF DRAWINGS

The above and other objects, features and other advantages of the present invention will be more clearly understood from the following detailed description taken in conjunction with the accompanying drawings, in which:

FIG. 1 is a schematic view illustrating a configuration of an apparatus for dispersing and mixing fluids by focused ultrasound according to an embodiment of the present invention;

FIG. 2 is a perspective view and a block diagram illustrating an example of a detailed configuration of a fluid dispersion unit for implementing the embodiment of the present invention;

FIG. 3 is a block diagram showing a configuration for controlling a fluid circulation unit according to another embodiment of the present invention;

FIGS. 4 to 6 are schematic side-regional views illustrating conventional ultrasound dispersion devices;

FIG. 7 is a flowchart illustrating a method for dispersing and mixing fluids by focused ultrasound according to an embodiment of the present invention;

FIG. 8 is a block diagram illustrating a configuration of a fluid feeder for dispersing and mixing fluids by focused ultrasound according, to an embodiment of the present invention;

FIG. 9 illustrates an example of configurations of a fluid storage unit and a connector according to another embodiment of the present invention;

FIG. 10 is a schematic view illustrating a dispersion level of the fluid mixture for implementing the embodiment of the present invention;

FIGS. 11 to 14 are graphs and microscopic images showing results of testing for dispersing and mixing samples according to an embodiment of the present invention; and

FIGS. 15 and 16 are graphs showing transmission and backscattering of the dispersed fluid mixture with time based on results of testing for dispersing and mixing samples according to the embodiment of the present invention.

### BEST MODE FOR CARRYING OUT THE INVENTION

Hereinafter, an apparatus and method for dispersing and mixing fluids by focused ultrasound and a fluid feeder for dispersing and mixing fluids by focused ultrasound will be described in detail.

FIG. 1 is a schematic view illustrating a configuration of an apparatus for dispersing and mixing fluids by focused ultrasound according to an embodiment of the present invention.

Referring to FIG. 1, the apparatus for dispersing and mixing fluids by focused ultrasound according to the embodiment of the present invention includes a fluid storage unit 10, a fluid dispersion unit 20 and a fluid circulation unit 30 and a fluid flow path 40 through which the fluid mixture flows according to function performance of the components is provided such that the fluid flow path 40 connects between the fluid storage unit 10, the fluid dispersion unit 20 and the fluid circulation unit 30, as shown in FIG. 1.

The fluid storage unit 10 stores a fluid mixture containing at least two fluids which have different specific gravities and comprise a hydrophilic substance and a hydrophobic substance and comprises a first connector 11 and a second connector 12 connected to the fluid flow path so that the fluid mixture flows through the fluid flow path 40 providing a portion enabling the stored fluid mixture to move.

The fluid mixture is stored in the fluid storage unit 10 and is composed of at least a hydrophilic substance and a hydrophobic substance. That is, the fluid mixture is basically composed of two or more substances immiscible with one another.

The first connector 11 is mounted at least lower than the highest fluid surface when the fluid mixture is stored in the fluid storage unit 10 and is mounted higher than the second connector 12. For example, when the fluid mixture is composed of water and a hydrophobic substance having a lower specific gravity than water, a portion of the fluid mixture that is insufficiently dispersed, that is, a portion of the fluid mixture in which a hydrophobic substance having a low specific gravity is incompletely mixed with water should be incorporated in the fluid flow path 40 through the first connector 11. However, positions at which the first connector 11 and the second connector 12 are mounted may be changed according to specific gravity of the hydrophobic and hydrophilic substances.

That is, as described above, any structure may be used so long as the portion of fluid mixture, that is relatively insufficiently dispersed, flows from the fluid storage unit 10 to the fluid dispersion unit 20 through the first connector 11 and the fluid mixture dispersed by the fluid circulation unit 30 as described later returns to the fluid storage unit 10 from the fluid dispersion unit 20 through the second connector 12.

The fluid storage unit 10 may have a cylindrical structure or a variety of structures, for example, a structure having a plurality of barriers having different heights. There is no limitation as to the structure of the fluid storage unit 10 so long as the fluid storage unit 10 enables circulation of the fluid mixture.

The fluid dispersion unit 20 functions to focus ultrasound upon a portion of the fluid flow path 40 and thereby disperse and mix substances, that is, fluids, contained in the fluid mixture by focused ultrasound when the fluid mixture moves to the portion while the fluid mixture circulates through the fluid flow path 40.

For example, when it is assumed that the fluid mixture contains water and an oil, the fluid dispersion unit 20 focuses ultrasound upon the fluid mixture moving through the portion of the fluid flow path 40 and thereby homogeneously disperse oil particles in water.

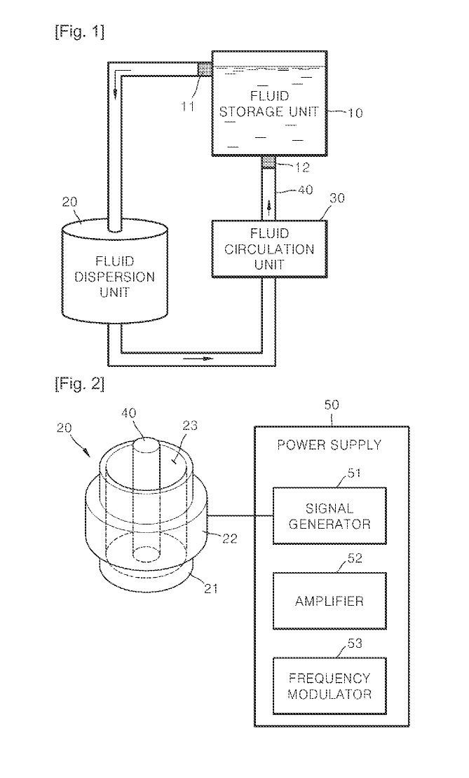

An example of a specific configuration of the fluid dispersion unit 20 is shown in FIG. 2. FIG. 2 is a perspective view and a block diagram illustrating an example of a detailed configuration of the fluid dispersion unit 20 for implementing the embodiment of the present invention.

The fluid dispersion unit 20 includes an ultrasound focusing unit (not represented by a reference number) including a focusing tube 21 and a piezoelectric vibrator 22, and a medium 23. Any configuration of the fluid dispersion unit 20 may be used without limitation to the configuration shown in FIG. 2 so long as the fluid dispersion unit 20 focuses ultrasound upon the flow path of two or more substances immiscible with each other to disperse and mix the substances.

The focusing tube 21 surrounds the portion of the fluid flow path 40 and is provided with a hollow. The focusing tube 21 preferably has a cylindrical shape having an axis formed in a longitudinal direction of the fluid flow path 40. In an embodiment, the focusing tube 21 is made of a material such as aluminum and any material may be used for the focusing tube 21 so long as the material transfers ultrasound generated by the piezoelectric vibrator 22 to the fluid flow path 40.

In an embodiment of the present invention, the piezoelectric vibrator 22 utilizes, as a device for converting electrical energy applied from a power supply 50 into ultrasonic energy, a piezoelectric ceramic transducer including lead, zirconium and titanium. Any energy converter may be used as the piezoelectric vibrator 22 so long as it is capable of performing such function.

The piezoelectric vibrator 22 functions to vibrate in a radial direction in the hollow cylinder of a metallic tube 21 upon application of electrical energy. The medium 23 fills the focusing tube 21, so that ultrasound generated by the piezoelectric vibrator 22, that is, the ultrasound focusing unit, is transferred to the medium 23 and is then converged to the center of the focusing tube 21, and as a result, strongly focused ultrasound field is created in the center of the focusing tube 21.

In this case, one portion of the fluid flow path 40 is preferably formed in the center of the axis of the focusing tube 21, that is, the center of the focusing tube 21 where the strong focused ultrasound field is created. As a result, two or more substances immiscible with each other in the fluid mixture are dispersed into nanoparticles, cohesion therebetween decreases and the substances are homogeneously mixed with each other.

The hydrophilic and hydrophobic substances are divided based on affinity to water and are classified according to geometric shape of water drops on the flat surface. An angle between the edge of water drops and the surface thereof is defined as a contact angle, the corresponding surface is defined as being hydrophilic when the contact angle is not higher than 90 degrees, and the corresponding surface is defined as being hydrophobic when the contact angle is not less than 90 degrees.

Specifically, the hydrophilic substance ma comprise polar molecules having an electrically asymmetrical structure while the hydrophobic substance may comprise molecules having an electrically symmetrical structure.

For dissolution between the substances, a mixture having both hydrophilic and hydrophobic groups, such as an emulsifier, may be added.

However, the emulsifier is a chemical substance which is unsafe to the human body upon use for cosmetics, medical liquids, edible liquids and the like and the substances are disadvantageously separated again with time in spite of adding an emulsifier.

Accordingly, a process of removing cohesive force, enabling substances having the same property to attract each other, and of dispersing the substances having different properties is required to homogeneously mix, that is, dissolve the hydrophilic and hydrophobic substances without adding the emulsifier.

For this purpose, cohesion between substances is reduced by applying the ultrasound and side-regional views of conventional ultrasound dispersion devices excluding the embodiments of the present invention are shown in FIGS. 4 to 6.

First, referring to FIG. 4, a bath-type ultrasound dispersion device is shown. The bath-type ultrasound dispersion device includes an ultrasonic wave generator 100 disposed at both sides of a target substance 120 and transfers ultrasound from the sides toward the target substance 120 through a medium 110.

Meanwhile, a cup-type ultrasound dispersion device shown FIG. 5 includes an ultrasonic wave generator 200 disposed on the bottom of a target substance 220 and transfers ultrasound from the bottom toward the target substance 220 through a medium 210.

Meanwhile, a horn-type ultrasound dispersion device shown in FIG. 6 includes an ultrasonic wave generator 300 disposed in the center of a target substance 320 and directly transfers ultrasound to the target substance 320.

The ultrasound dispersion devices shown in FIGS. 4 to 6 generate considerably low frequency (about 20 kHz) of ultrasounds and are unsuitable for dispersion of fluids due to excessively large wavelength as compared to the size of particles upon dispersion of fluid particles at nano-scale, constructive interference and destructive interference between ultrasounds result from multiple reflections from the wall of the container or the like due to the structure shown in FIGS. 4 to 6 and sound pressures are heterogeneously distributed in the target substance. Accordingly, a region where dispersion is good and a region where dispersion is poor are present and dispersion efficiency is thus disadvantageously greatly decreased.

In addition, the bath or horn-type ultrasound dispersion device generates heat, thus disadvantageously having low efficiency upon use for a long time and causing a phenomenon in which aggregated particles are not dispersed and clump together.

In particular, non-uniformity of sound pressure distribution and the like causes heterogeneous cavitation as described above, thus resulting in great deterioration in dispersibility.

In addition, only ultrasounds having a considerably low frequency are useful because ultrasounds are not focused. The size of dispersed particles is inevitably a micrometer scale, as described above. There is a problem in that the fluid mixture is separated into the hydrophobic substance and the hydrophilic substance with time due to strong cohesion between particles.

However, in accordance with the configuration of the focusing tube 21, the piezoelectric electric vibrator 22 and the medium 23 of the present invention, ultrasounds are strongly focused on one portion of the fluid flow path 40. That is, as can be seen from the test example of the present invention, as compared to conventional ultrasound dispersion devices shown in FIGS. 4 to 6, the frequency of focused ultrasound is about 400 kHZ and dispersion is performed with an energy of a considerably high frequency (short wavelength). For this reason, particles of hydrophilic and hydrophobic substances such as water and oils is considerably emulsified to a small size, for example, is nano-emulsified at a nanometer scale, as compared to the conventional methods, thereby providing more effective dispersion and homogeneous cavitation due to the structure thereof, and greatly improving maintenance of dispersion and thus dispersion efficiency.

In addition, when the medium 23 is composed of water, glycerin, or a mixture of water and glycerin, efficiency of transferring sound wavelengths to the piezoelectric vibrator 22 may be considerably high and dispersion efficiency may be improved.

The power supply 50 is composed of a signal generator 51 and an amplifier 52 and is electrically connected to piezoelectric vibrator 22 of the ultrasound focusing unit, to supply electrical signal, that is, electrical energy to the piezoelectric vibrator 22, and to allow the piezoelectric vibrator 22 to generate ultrasound. Like the other elements, any element may be used as the power supply 50 so long as it supplies electrical energy for generating ultrasound to the piezoelectric vibrator 22.

The power supply 50 may further include a frequency modulator 53. The frequency modulator 53 functions to modulate the frequency of ultrasound generated by the ultrasound focusing unit, specifically, the piezoelectric vibrator 22.

The fluid mixture may include, in addition to certain substances, a variety of substances, according to the demand of the user. In this case, modulation of frequency of ultrasound applied to the fluid mixture is required in order to more effectively disperse the fluid mixture. For this purpose, the frequency modulator 53 modulates frequency of ultrasound generated by the piezoelectric vibrator 22.

In order to entirely disperse and mix the fluid mixture through the configuration of the fluid dispersion unit 20 as described above, the fluid mixture should be circulated from the fluid storage unit 10 to the fluid dispersion unit 20 through the fluid flow path 40 and be circulated again from the fluid dispersion unit 20 to the fluid storage unit 10 through the fluid flow path 40.

The fluid circulation unit 30 circulates the fluid mixture such that a portion of the fluid mixture having a relatively low specific gravity is moved from the fluid storage unit 10 to the fluid dispersion unit 20 through the first connector 11 and the fluid mixture dispersed and mixed by the fluid dispersion unit 20 is moved to the fluid storage unit 10 through the second connector 12.

Referring to the configuration associated with the fluid storage unit 10 and the fluid circulation unit 30 shown in FIG. 1, the mixture entering the fluid dispersion unit 20 through the first connector 11 is a portion of the mixture in which hydrophilic and hydrophobic substances are relatively insufficiently dispersed, as described associated with the fluid storage unit 10 above.

Based on such a configuration, the fluid mixture containing the hydrophilic and hydrophobic substances passes through areas upon which ultrasounds are strongly focused so that particles are dispersed and dissolved. In addition, a greater amount of the mixture relatively insufficiently dissolved is flowed to the fluid dispersion unit 20 based on the configuration of the fluid storage unit 10, so that dispersion efficiency can be advantageously improved.

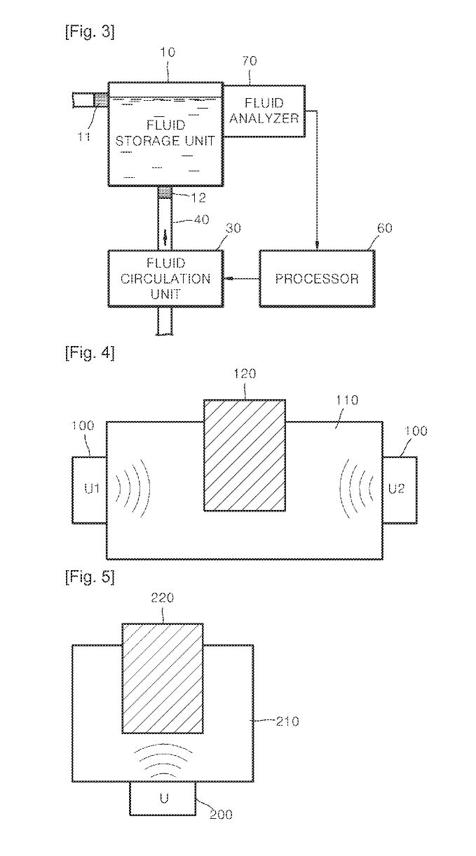

FIG. 3 is a block diagram showing elements for controlling the fluid circulation unit according to another embodiment of the present invention.

As described with reference to FIGS. 1, 2, and 4 to 6, the fluid circulation unit 30 functions to circulate the fluid mixture to the fluid storage unit 10 and the fluid dispersion unit 20.

The fluid circulation unit 30 should be driven for a long time in terms of dispersion capability, but preferably stops driving in terms of energy saving when it is considered to be substantially completely dispersed according to dispersion standard.

For this purpose, referring to FIG. 3, a fluid analyzer 70 and a processor 60 are further added as elements for controlling the fluid circulation unit 30 according to another embodiment of the present invention.

Based on the fluid flow path 40, the fluid circulation unit 30 supplies the dispersed fluid mixture to the fluid storage unit 10 through the second connector 12 and supplies the fluid mixture stored in the fluid storage unit 10 to the fluid dispersion unit 20 through the first connector 11.

In this case, the fluid analyzer 70 is mounted at a side of the fluid storage unit 10 to measure a dispersion level of the fluid mixture. In the embodiment of the present invention, the fluid analyzer 70 includes a sensor for measuring information such as zeta potential, particle size, density, concentration, refractive index, color and the like of the fluid mixture, to measure dispersion level and to transmit the corresponding information to the processor 60 so that the processor 60 can control operations of the fluid circulation unit 30 and the fluid dispersion unit 20.

Zeta potential is an index indicating a level of repulsive or attractive force between particles. The measured zeta potential provides better and accurate understanding of dispersion mechanisms and acts as an essential factor for controlling dispersion of respective particles.

High zeta potential means that repulsive force between particles is strong and the particles are stable. Low zeta potential means that cohesion between particles is strong. Charges of particles are adhered to free ions to create an electron crowd having electricity double layers. A decrease in voltage caused by the electricity double layers is an important parameter for colloid. Zeta potential is changed depending on properties of colloid. That is, zeta potential is used as a Major index of colloid behaviors.

A liquid layer disposed around particles is present as two regions. Ions are strongly bonded to an inner region and particles do behaviors as single objects in an outer region. The potential at the boundary between the regions is referred to as zeta potential. In general, the boundary voltage of zeta potential is ±30 mv and particles to which a voltage higher than the corresponding voltage is applied have enough high repulsive force so that the particles become stable.

That is, as zeta potential increases, the repulsive force between particles increases and the particles are considered to be dispersed, instead of being aggregated. The fluid analyzer 70 according to the present invention measures zeta potential of the fluid mixture, thereby measuring dispersion level between substances contained in the fluid mixture.

Any apparatus may be used as the fluid analyzer 70 so long as it is capable of measuring a dispersion level of substances contained in the fluid mixture.

The processor 60 functions to receive zeta potential of the fluid mixture measured by the fluid analyzer 70 and control of operations of the fluid circulation unit 30 according to the received zeta potential.

Specifically, the processor 60 determines that the cohesive force between substances is considerably strong, when the zeta potential of the fluid mixture is considered to be less than a predetermined critical potential (potential value, abstract value of which is higher than ±30 mv) and then controls the fluid circulation unit 30 to circulate the fluid mixture as described above, and determines that the fluid mixture is stably dispersed and mixed when the zeta potential of the fluid mixture is considered to be not less than the critical potential and stops the operation of the fluid circulation unit 30.

Meanwhile, in another embodiment of the present invention, the processor 60 controls not only operation of the fluid circulation unit 30, but also, for example, operation of the fluid dispersion unit 20. The control of the operation of the fluid dispersion unit 20 means control of frequency of the fluid dispersion unit 20 or control of whether or not operation is performed.

As such, the operation of the fluid circulation unit 30 is controlled and the fluids are thus advantageously more efficiently dispersed and mixed by measuring dispersion level of the fluid mixture in real-time. In reality, as can be seen from an experimental example according to one embodiment of the present invention, the dispersed sample has a zeta potential of −25 mV to −50 mV and the zeta potential value is maintained for a long time, which means that dispersion is considerably stably maintained.

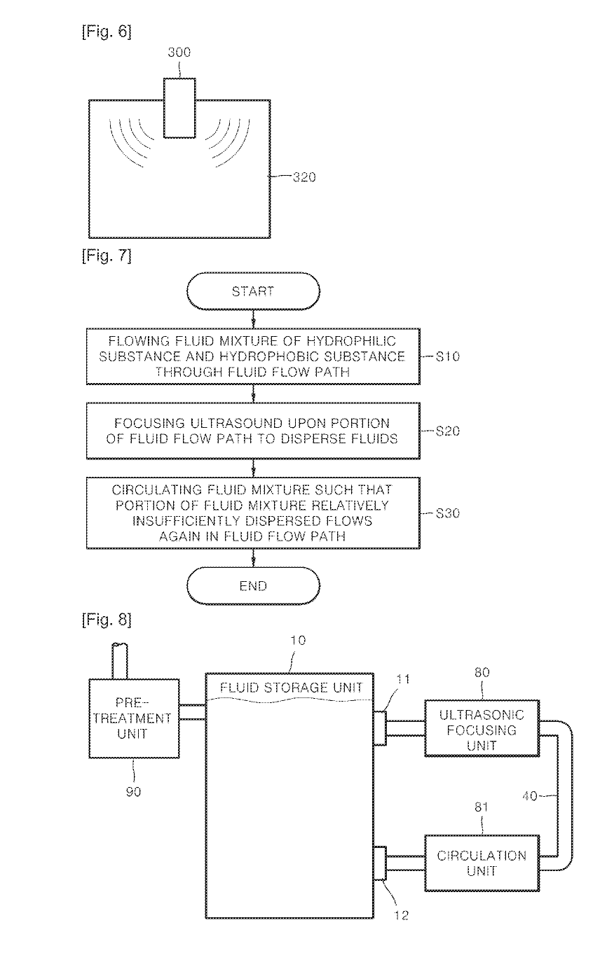

FIG. 7 is a flowchart illustrating a method for dispersing and mixing fluids by focused ultrasound according to one embodiment of the present invention. In the following description, the contents overlapping the description with reference to FIGS. 1 to 6 are omitted.

Referring to FIG. 7, in the method for dispersing and mixing fluids by focused ultrasound according to one embodiment of the present invention, the fluid mixture is moved through the fluid flow path (S10). The movement of the fluid mixture through the fluid flow path is preferably associated with the functions of the fluid storage unit and fluid circulation unit as described with reference to FIGS. 1 to 6, but the present embodiment is also provided as an embodiment of the method for dispersing and mixing fluids by focused ultrasound according to one embodiment of the present invention and is not limited to the configuration shown in FIGS. 1 to 6.

Then, ultrasound is focused to one portion of the fluid flow path, to disperse and mix fluids contained in the fluid mixture into nanometer-scale particles by focused ultrasound when the fluid mixture is flowed, that is, transferred to one portion (S20). This is the same as in the description associated with the function of the fluid dispersion unit with reference to FIGS. 1 to 6.

Then, as can be seen from the description associated with the fluid circulation unit with reference to FIGS. 1 to 6, the portion of fluid mixture relatively insufficiently dispersed is circulated such that the portion of fluid mixture flows again in the fluid flow path (S30).

As described with reference to FIGS. 1 to 6 above, regarding the description associated with the steps S10 and S30, the fluid mixture may, for example, contain water and a hydrophobic substance having a lower specific gravity than water. In the step S30, the fluid circulation unit may perform its function to circulate a portion of the fluid mixture having a relatively low specific gravity.

Meanwhile, like the function of the fluid analyzer shown in FIG. 3, in another embodiment of the present invention, measuring information indicating a dispersion level of the fluid mixture by a sensor and controlling circulation of the fluid mixture may be further performed. As described above, information indicating the dispersion level of the fluid mixture measured by the sensor includes zeta potential, particle size, density, concentration, refractive index, color and the like.

In addition, information that can be controlled by the step S20 may include not only control of circulation of the fluid mixture but also control of frequency of ultrasound and whether or not a means for generating ultrasound is operated, as described in association with the step S20 with reference to FIGS. 1 to 6.

FIG. 8 is a block diagram illustrating a configuration of a fluid feeder for dispersing and mixing fluids by focused ultrasound according to one embodiment of the present invention. The contents of the following description overlapping those shown in FIGS. 1 to 7 are omitted and in the following description, components which are represented by different reference numerals although they perform the same function as shown in FIGS. 1 to 7 will be understood to be like components.

Referring to FIG. 8, the fluid feeder for dispersing fluids by focused ultrasound according to one embodiment of the present invention includes a fluid storage unit 10 and a pre-treatment unit 90.

The fluid storage unit 10 stores the fluid mixture circulated by an ultrasound focusing unit 80 and a circulation unit 81 described below. In the present invention, as described above, the fluid mixture means a fluid in which a hydrophilic fluid is mixed with a hydrophobic fluid. The fluid mixture is for example a fluid in which water is mixed with an oil and the example of the fluid mixture is not limited thereto.

In addition, the ultrasound focusing unit 80 described below means an element having the same function as the fluid dispersion unit in the description with reference to FIGS. 1 to 7 and the circulation unit 81 means an element having the same function as the fluid circulation unit.

The fluid mixture stored in the fluid storage unit 10 is moved through the fluid flow path 40 and is preferably moved through the fluid flow path 40 by the circulation unit 81.

That is, the fluid mixture is dispersed and mixed by the ultrasound focusing unit 80 while it circulates through the fluid flow path 40 from the fluid storage unit 10. The ultrasound focusing unit 80 is mounted on one portion of the fluid flow path 40, as shown in FIG. 8.

Based on such a configuration, when the fluid mixture moving through the fluid path 40 reaches one portion in which the ultrasound focusing unit 80 is mounted, ultrasounds generated by the ultrasound focusing unit 80 are focused upon the fluid flow path 40, as described with reference to FIGS. 1 to 7, and fluids contained in the fluid mixture are dispersed at a nanometer scale by the focused ultrasound and are mixed without using an emulsifier.

The fluid mixture dispersed and mixed by the ultrasound focusing unit 80 flows again in the fluid storage unit 10 through the fluid flow path 40 by the circulation unit 81.

As the function is repeatedly performed, the fluid mixture, which is simply mixed in the fluid storage unit 10, is completely dispersed and homogeneously mixed. The fluid mixture can be considerably homogeneously dispersed and mixed by nanometer-scale dispersion, as compared to other mechanical mixing, mixing with an emulsifier and mixing using a conventional ultrasonic mixer. In particular, a phenomenon, in which particles are re-aggregated with the portion of time and the hydrophilic fluid is thus separated from the hydrophobic fluid, is minimized.

Meanwhile, as shown in FIG. 8, the fluid storage unit 10 is connected to the fluid flow path 40 through the first connector 11 and the second connector 12.

The first connector 11 is formed to flow a portion of the fluid mixture stored in the fluid storage unit 10, that is relatively insufficiently dispersed, from the fluid storage unit 10 to the fluid flow path 10 and the second connector 12 is formed to flow the fluid mixture dispersed and mixed by the ultrasound focusing unit 80 from the fluid flow path 40 to the fluid storage unit 10.

As a result, as the circulation unit 81 operates, the fluid mixture circulates such that it passes through the fluid storage unit 10, the first connector 11, the fluid flow path 40 and the second connector 12 in order.

The positions at which the first connector 11 and the second connector 12 are formed can be determined according to, for example, specific gravity.

That is, the fluid mixture is in a state in which the hydrophilic fluid is mixed with the hydrophobic fluid and the first connector 11 is mounted higher than the second connector 12 when the fluid mixture is composed of water and a hydrophobic substance having a lower specific gravity than water. That is, the reason for this is that a portion of the fluid mixture in which the hydrophobic substance having a lower specific gravity is relatively insufficiently mixed with water should flow in the fluid flow path 40 through the first connector 11. However, the positions at which the first connector 11 and the second connector 12 are mounted may be changed according to specific gravity of the hydrophobic and hydrophilic substances.

That is, as described above, any configuration may be used so long as the portion of the fluid mixture relatively insufficiently dispersed flows from the fluid storage unit 10 into the fluid flow path 40 through the first connector 11 and the fluid mixture dispersed by the ultrasound focusing unit 80 described below flows again into the fluid storage unit 10 through the second connector 12.

The fluid storage unit 10 may have a variety of structures such as a cylindrical structure or a structure including a plurality of barriers having different heights. The fluid storage unit 10 may have any structure so long as the shape enables circulation of the fluid mixture described below.

Meanwhile, another example of the respective connectors 11 and 12 is shown in FIG. 9. FIG. 9 illustrates an example of the structure of the fluid storage unit and the connector according to another embodiment of the present invention.

Referring to FIG. 9, the fluid mixture stored in the fluid storage unit 10 may, for example, be divided into three regions A, B and C according to specific gravity. In this case, the first connectors 111 and 112 correspond to two connectors, respectively, mounted in an area where the fluid mixture of a region A having the lowest specific gravity is present and in an area where the fluid mixture of a region C having the highest specific gravity is present.

During dispersing, the fluid mixture is divided into the region C where a concentration of a fluid having a higher specific gravity among the hydrophilic and hydrophobic fluids is high, the region A where a concentration of a fluid having a lower specific gravity is high, and the region B where a specific gravity is the median value between the regions A and C because the fluids are relatively homogeneously mixed.

Considering the functions of the present invention, the fluid mixture is divided into the regions A to C in order of concentration of the fluid having a low specific gravity to the fluid having a high specific gravity.

That is, a region where a concentration of the fluid having a low specific gravity is high means a region where a ratio of the fluid having a low specific gravity is high as compared to other regions, and a region where a concentration of the fluid having a low specific gravity is low means a region where a ratio of the fluid having a high specific gravity is high, as compared to other regions. When dividing the fluid mixture into the regions A to C, based on this criteria, the region A is a region where a concentration of the fluid having the lowest specific gravity is the highest, the region C is a region where a concentration of the fluid having the lowest specific gravity is the lowest and the region B is a region having a median value between concentrations of the regions A and C.

Accordingly, as described above, mixed fluids present in the region where the concentration of the fluid having a low specific gravity is the lowest, and the region where the concentration of the fluid having a low specific gravity is the highest, that is, regions where there is a relative difference in compositional ratio of the fluid should be fed to the fluid flow path 40 for homogeneous mixing. Accordingly, the first connectors 111 and 112 are preferably formed in the regions A and C, respectively. Meanwhile, the dispersed fluid mixture is preferably fed into the region B.

By forming the first connectors 111 and 112 in the regions A and C, respectively, regions where the fluid having a low specific gravity is high and low in concentration are homogeneously fed into the fluid flow path 40, thereby further improving dispersion and mixing efficiencies.

In such a structure, the fluid having a low specific gravity is moved again to the region A according to dispersion level and the concentration of the fluid having a low specific gravity is naturally kept high in the region A. On the other hand, the fluid having a high specific gravity is moved again to the region C according to dispersion level and regarding the relative concentration ratio, the concentration of the fluid having a low specific gravity is the lowest in the region C.

As a result of repetition of such a treatment process, the difference in the concentration of the fluid having a low specific gravity to the fluid having a high specific gravity between the regions is gradually decreased and complete dispersion is thus realized.

As the first connectors 111 and 112 are mounted in the regions A and C, the second connector 12 is preferably mounted in the region B, as described above.

Referring to FIG. 1 again, for dispersing and mixing the fluid mixture, the fluid mixture is fed from the fluid storage unit 10 to the fluid flow path 40 and the ultrasound focusing unit 80. In the present invention, as shown in FIG. 1, the fluid mixture is subjected to a series of treatment processes by the pre-treatment unit 90 and is then supplied to the fluid storage unit 10.

Before the fluid mixture is stored in the fluid storage unit 10, the pre-treatment unit 90 disperses the fluid mixture at micrometer scale and then supplies the same to the fluid storage unit 10.

As described above, the fluid mixture of the hydrophilic fluid and the hydrophobic fluid is stored in the fluid storage unit 10. In this case, without performing dispersing and mixing absolutely, only the hydrophilic or hydrophobic fluid is fed, or although both the hydrophilic fluid and the hydrophobic fluid are fed, the ratio of the fluids tend to be not homogeneous, according to configuration of the respective connectors in spite of using the ultrasound focusing unit 80.

The ultrasound focusing unit 80 functions to disperse particles of fluids composed of the hydrophilic fluid and the hydrophobic fluid at a nanometer scale and thereby to homogeneously mix the respective fluids. Accordingly, as described above, when the fluid mixture which is not dispersed and mixed at all is fed, dispersion and mixing efficiencies may be deteriorated.

Accordingly, before the fluid mixture is stored in the fluid storage unit 10, the pre-treatment unit 90 disperses the fluid mixture at micrometer scale into a pre-mix state in which the hydrophilic fluid and the hydrophobic fluid are relatively homogeneously mixed and stores the pre-mixed fluid mixture in the fluid storage unit 10.

The pre-treatment unit 90 may for example include a bath-, cup-, or horn-type dispersing apparatus or a combination thereof as the conventional ultrasound dispersion device. However, any dispersing apparatus may be included in the pre-treatment unit 90 so long as it performs the function of the pre-treatment unit 90, i.e., the function of dispersing and mixing respective particles of the fluid mixture at micrometer scale.

Meanwhile, as shown in FIG. 8, the position at which the fluid flow path for feeding the fluid mixture pre-treated by the pre-treatment unit 90 to the fluid storage unit 10 is connected to the fluid storage unit 10 corresponds to the top of the fluid storage unit 10, but the corresponding position is not limited to that shown in FIG. 8 and may be any position other than the top of the fluid storage unit 10.

In accordance with the configuration of the connector shown in FIG. 9 and the configuration of the pre-treatment unit 90 shown in FIG. 1, as described above, deterioration in dispersion and mixing efficiencies that may be generated when the fluid mixture is immediately supplied to the ultrasound focusing unit 80 can be effectively solved. There are effects in that dispersion and mixing efficiencies of the fluid mixture are greatly improved and production efficiency of the fluid mixture is greatly improved.

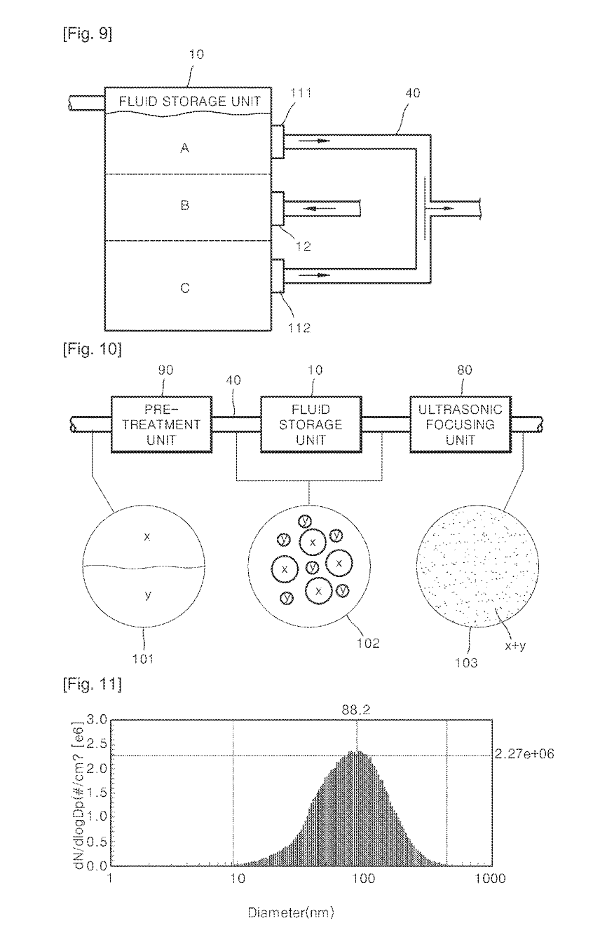

FIG. 10 is a schematic view illustrating a dispersion level of the fluid mixture according to an embodiment of the present invention.

Referring to FIG. 10, the fluid mixture may be classified into a first fluid mixture 101, a second fluid mixture 102 and a third fluid mixture 103.

The first fluid mixture 101 is a fluid mixture which is not dispersed at all and is in a state in which a hydrophilic substance y is completely separated from a hydrophobic substance x. In this case, when the first fluid mixture 101 is primarily dispersed at micrometer scale by the pre-treatment unit 90, it is converted into the second fluid mixture 102 in which the hydrophilic substance y and the hydrophobic substance x are not completely dispersed and mixed, but are homogeneously distributed.

The second fluid mixture 102 is stored in the fluid storage unit 10, is then fed to the ultrasound focusing unit 80 and is converted into the third fluid mixture 103. The third fluid mixture 103 is shown as the fluid mixture after passing through the ultrasound focusing unit 80 in FIG. 10, but as described in FIGS. 8 and 9, the third fluid mixture 103 is considered to be a final product obtained by repeatedly circulating the fluid mixture through the ultrasound focusing unit 30 for a predetermined time.

The third fluid mixture 103 is in a state in which the hydrophilic substance y and the hydrophobic substance x are completely dispersed and mixed at a nanometer scale. The fluid mixture in such a state has enough stability so that the dispersed state is not almost changed even after a predetermined time because particles of fluids are homogeneously mixed.

As such, the present invention is effective in efficiently dispersing and mixing the hydrophilic fluid and the hydrophobic fluid at a high production efficiency to obtain a completely mixed fluid.

FIGS. 11 to 14 are graphs and microscopic images showing test results obtained by dispersing and mixing samples according to an embodiment of the present invention.

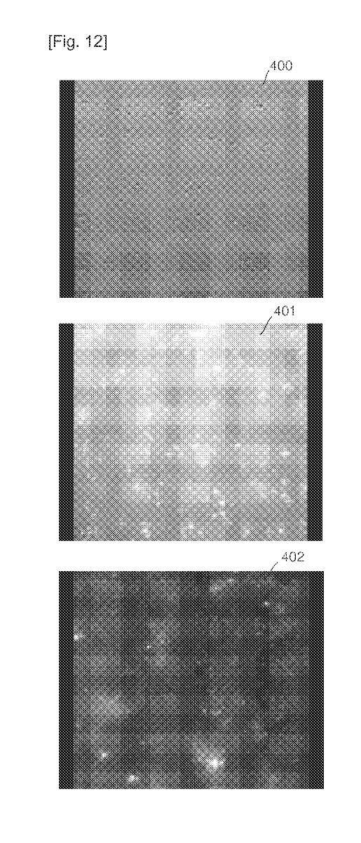

First, FIGS. 11 and 12 show test results obtained by adding, to water, 2 wt % of cetiol, which is immiscible with water and is considerably unsuitable for obtaining products, as a higher fat used for preparing cosmetics and medicines, and dispersing the resulting mixture using horn and bath type dispersion devices as conventional ultrasound dispersion devices and an apparatus for dispersing and mixing fluids by focused ultrasound according to the embodiment of the present invention.

FIG. 11 is a graph showing measurement results of particle size obtained after dispersion using an apparatus for dispersing and mixing fluids by focused ultrasound for a predetermined time. As can be seen from FIG. 11, regarding the particle size, a peak of is observed at about 82 nm and other peaks are not observed. This means that particles are not aggregated and are homogeneously dispersed and mixed.

Meanwhile, FIG. 12 shows a microscopic image 400 obtained by dispersing the constant fluid mixture using a horn-type dispersion apparatus, a microscopic image 401 obtained by dispersing the constant fluid mixture using a bath-type dispersion apparatus and a microscopic image 402 obtained by dispersing the constant fluid mixture using an apparatus for dispersing and mixing fluids by focused ultrasound.

As can be seen from the respective microscopic images of FIG. 12 and scale bars shown in the microscopic images, particles of the fluid mixture are dispersed as considerably small particles, as compared to other test examples, in the case of using the apparatus for dispersing and mixing fluids by focused ultrasound according to the present invention.

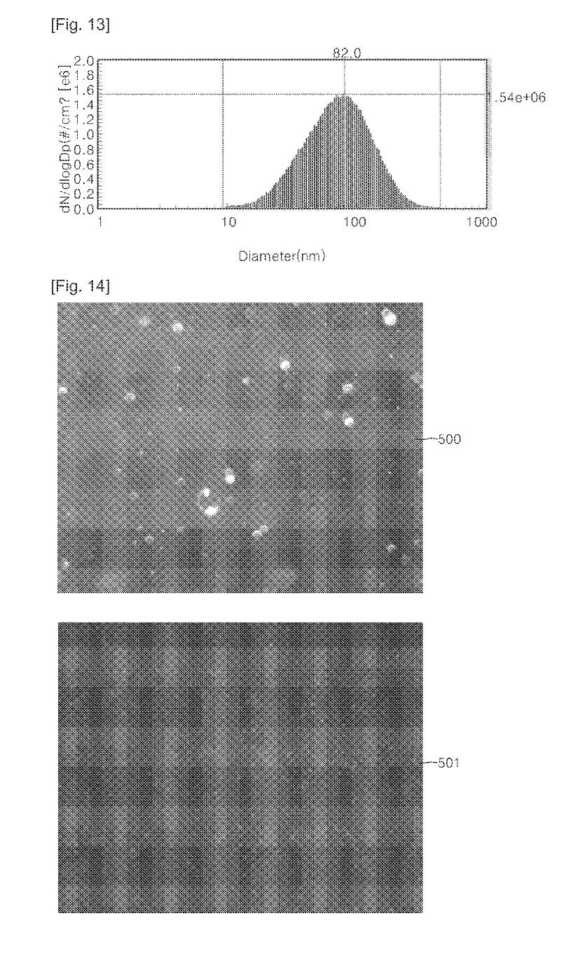

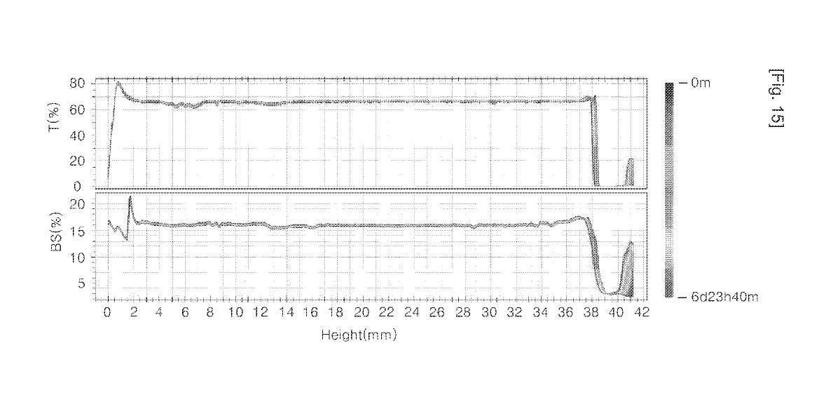

FIGS. 13 and 14 show test results obtained by adding, to water, capric triglyceride as a substance which is considerably immiscible with water, like the cetiol and then dispersing the resulting mixture using horn- and bath-type dispersion devices as conventional ultrasound dispersion devices and an apparatus for dispersing and mixing fluids by focused ultrasound.

FIG. 13 is a graph showing measurement results of particle size obtained after dispersion using an apparatus for dispersing and mixing fluids by focused ultrasound according to the embodiment of the present invention for a predetermined time. As can be seen from FIG. 13, regarding the particle size, a peak is observed at about 82 nm and other peaks are not observed. This means that particles are not aggregated and are homogeneously dispersed and mixed.

Meanwhile, FIG. 14 shows a microscopic image 500 obtained by dispersing the constant fluid mixture using a conventional bath+stir type dispersion apparatus and a microscopic image 501 obtained by dispersing the constant fluid mixture using the apparatus for dispersing and mixing fluids by focused ultrasound according to the embodiment of the present invention.

As can be seen from the respective microscopic images of FIG. 14 and scale bars shown in the microscopic images, particles of the fluid mixture are homogeneously dispersed as considerably small particles with a size of 100 nm, as compared to other test examples, by using the apparatus for dispersing and mixing fluids by focused ultrasound according to the present invention.

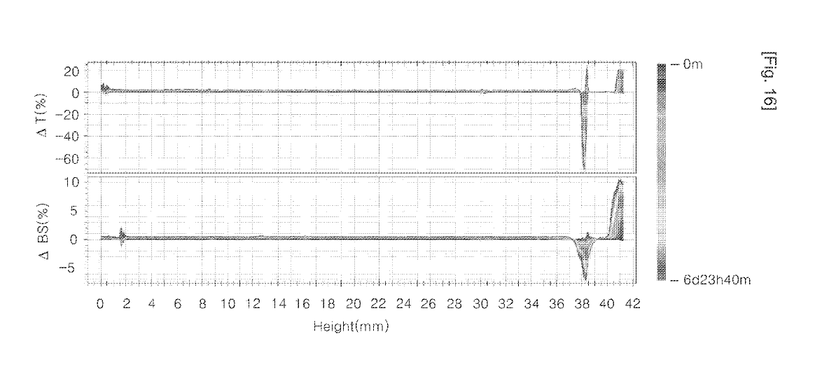

FIGS. 15 and 16 are graphs showing transmission and backscattering of the dispersed fluid mixture with time based on results of testing for dispersing and mixing samples according to the embodiment of the present invention.

FIGS. 11 to 14 show comparison results of dispersion levels of panicles in the case of dispersing the fluid mixture under the same conditions using conventional ultrasound dispersion devices and the apparatus for dispersing and mixing fluids by focused ultrasound according to the embodiment of the present invention.

Meanwhile, FIGS. 15 and 16 show experimental examples indicating that dispersion is maintained considerably stably even for a predetermined time upon use of the apparatus for dispersing and mixing fluids by focused ultrasound according to the present invention.

FIG. 15 is a graph showing transmission (T %) and backscattering (BS %) of the fluid mixture according to height of the sample on a predetermined time of 6 days 23 hours 40 minutes immediately after adding triglyceride to water, dispersing the resulting mixture using the apparatus for dispersing and then mixing fluids by focused ultrasound according to the present invention.

Referring to FIG. 15, transmission (T %) and backscattering (BS %) of the fluid mixture immediately after dispersion are respectively shown in blue graphs. Meanwhile, transmission (T %) and backscattering (BS %) of the fluid mixture on the longest time after dispersion are respectively shown in red graphs.

It can be seen from successive variation of the graph shown in FIG. 15 that a predetermined value is substantially maintained without variation according to respective heights of the fluid mixture. As a result, according to the present embodiment, the dispersion of the fluid mixture can be considerably stably maintained even after a predetermined time.

Meanwhile, FIG. 16 is a graph showing delta values, that is, variations, of transmission (ΔT %) and backscattering (ΔBS %) of the fluid mixture of FIG. 15.

Referring to FIG. 16, transmission variation (ΔT %) and backscattering variation (ΔBS%) of the fluid mixture immediately after dispersion are respectively shown in blue graphs. Meanwhile, transmission variation (ΔT %) and backscattering variation (ΔBS %) of the fluid mixture at the longest time after dispersion are respectively shown in red graphs.

As can be seen from FIG. 16, according to the present invention, the transmission variation (ΔT %) and backscattering variation (ΔBS %) reach about zero even for a predetermined time. Accordingly, the dispersion of the dispersed fluid mixture is maintained considerably stably.

Although all components implementing embodiments of the present invention have been described to be connected with one another or operate to be connected with one another, the present invention is necessarily not limited to the embodiments. That is, all the components may operate such that they are selectively combined with at least one.

In addition, it will be further understood that the terms “comprising”, “including” and “having” used above specify, unless otherwise defined, the presence of components and does not preclude the presence or addition of one or more other components. Unless otherwise defined, all terms (including technical and scientific terms) used herein have the same meaning as commonly understood by one of ordinary skill in the art to which the invention pertains. It will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

Accordingly, the embodiments disclosed herein are for the purpose of describing the technical concept of the invention only and are not intended to limit the technical concept of the invention. The scope of the present invention to be protected should be interpreted by the claims and all technical concepts equivalent thereto fall within the scope of the present invention to be protected.

1. An apparatus for dispersing and mixing fluids by focused ultrasound comprising:
a fluid storage unit for storing a fluid mixture of at least two fluids comprising a hydrophilic substance and a hydrophobic substance, and comprising a first connector and a second connector connected to a fluid flow path providing a path through which the fluid mixture flows to allow the fluid mixture to flow through the fluid flow path;
a fluid dispersion unit for focusing ultrasound to a portion of the fluid flow path to disperse the fluids contained in the fluid mixture by ultrasound when the fluid mixture reaches the portion of the fluid flow path; and
a fluid circulation unit for circulating the fluid mixture such that a portion of the fluid mixture relatively insufficiently dispersed flows through the first connector from the fluid storage unit to the fluid dispersion unit and the fluid mixture dispersed by the fluid dispersion unit flows through the second connector to the fluid storage unit.

2. The apparatus according to claim 1, wherein the fluid dispersion unit comprises:
an ultrasound focusing unit mounted to surround the portion of the fluid flow path, the ultrasound focusing unit comprising a hollow focusing tube and a piezoelectric vibrator connected to an outer circumference surface of the focusing tube and receiving power from a power supply to generate ultrasound; and
a medium filling the focusing tube to transfer ultrasound generated by the ultrasound focusing unit to the portion of the fluid flow path.

3. The apparatus according to claim 2, wherein the portion of the fluid flow path is positioned in the center of an axis of the focusing tube.

4. The apparatus according to claim 2, wherein the piezoelectric vibrator is a piezoelectric transducer.

5. The apparatus according to claim 2, wherein the power supply comprises:
a signal generator for supplying an electrical signal for generating ultrasound to the ultrasound focusing unit; and
an amplifier.

6. The apparatus according to claim 5, wherein the power supply further comprises:
a frequency modulator for modulating a frequency of the ultrasound generated by the ultrasound focusing unit.

7. The apparatus according to claim 1, further comprising:
a fluid analyzer mounted in the fluid storage unit, the fluid analyzer measuring information indicating a dispersion level of the fluid mixture; and
a processor for controlling an operation of the fluid circulation unit according to the information indicating the dispersion level of the fluid mixture.

8. The apparatus according to claim 7, wherein the fluid analyzer comprises a sensor for measuring at least one of zeta potential, particle size, density, concentration, refractive index and color of the fluid mixture and transmits the information measured by the sensor to the processor.

9. A method for dispersing and mixing fluids by focused ultrasound comprising:
flowing a fluid mixture of at least two fluids comprising a hydrophilic substance and a hydrophobic substance through a fluid flow path;
focusing ultrasound upon a portion of the fluid flow path to disperse the fluids contained in the fluid mixture by focused ultrasound when the fluid mixture reaches the portion of the fluid flow path; and
circulating the fluid mixture such that a portion of the fluid mixture relatively insufficiently dispersed flows again in the fluid flow path.

10. The method according to claim 9, wherein the fluid mixture comprises at least water and a hydrophobic substance having a lower specific gravity than water, and
the circulating comprises circulating the fluid mixture such that a portion of the fluid mixture having a lower specific gravity flows again in the fluid flow path.

11. A fluid feeder comprising:
a fluid storage unit for providing a fluid flow path through which a fluid mixture of a hydrophilic fluid and a hydrophobic fluid flows, the fluid storage unit being connected through a plurality of connectors to the fluid flow path having a portion, in which an ultrasound focusing unit for focusing ultrasound to disperse and mix the fluids contained in the fluid mixture by focused ultrasound is mounted, to flow the fluid mixture in the fluid flow path and to flow the fluid mixture dispersed by the ultrasound focusing unit through the fluid flow path; and
a pre-treatment it for dispersing the fluid mixture at micrometer scale and supplying the same to the fluid storage unit before the fluid mixture is stored in the fluid storage unit.

12. The fluid feeder according to claim 11, wherein the connectors comprise:
a first connector for flowing a portion of the fluid mixture relatively insufficiently dispersed from the fluid storage unit into the fluid flow path; and
a second connector for flowing the fluid mixture dispersed by the ultrasound focusing unit from the fluid flow path into the fluid storage unit.

13. The fluid feeder according to claim 12, wherein the fluid storage unit further comprises:
a circulation unit for circulating the fluid mixture such that the fluid mixture flows through the first connector, the fluid flow path and the second connector in order.

14. The fluid feeder according to claim 12, wherein the fluid mixture comprises water and a hydrophobic substance having a lower specific gravity than water, and
the first connector is mounted higher than the second connector.

15. The fluid feeder according to claim 12, wherein the first connector comprises two connectors respectively mounted in areas in which the fluid mixture present in a region having the lowest specific gravity and the fluid mixture present in a region having the highest specific gravity are disposed, and the second connector is mounted in an area other than the two areas in which the first connector is mounted, when the fluid mixture stored in the fluid storage unit is divided into three regions according to specific gravity.
